(19) United States
(12) Patent Application Publication
(10) Pub. No.: US 2013/0152193 A1
(43) Pub. Date: Jun. 13, 2013

(54) METHOD FOR AUTHENTICATION WITH DYNAMIC AND RANDOM PASSWORDS

(71) Applicant: Pei-An Cheng, Kaohsiung City (TW)

(72) Inventor: Pei-An Cheng, Kaohsiung City (TW)

(21) Appl. No.: 13/707,620

(22) Filed: Dec. 7, 2012

(30) Foreign Application Priority Data
Dec. 8, 2011 (TW) 100145346

(51) Int. Cl. G06F 21/31

(52) U.S. Cl. CPC G06F 21/31
USPC 726/19

(57) ABSTRACT

An approach is provided for a method for authentication with dynamic and random passwords, which comprises acts of obtaining a code equation initially from a person through an register page of a system, generating a starting code set and a result value, obtaining a password from the person through an authentication page of the system, determining the identity of the result value and the password, and granting the person for the authentication when the password and the result value are the same. The code equation is formed by at least one mathematical equation. The result value is the calculation result of the starting code set and the code equation. The starting code set is a set of number randomly generated by the system. Therefore, the present invention is able to prevent password cracking or recovering from data that has been stored in or transmitted by an apparatus.

### FIELD OF THE INVENTION

Embodiments of the present invention relate to a cryptanalysis authentication, and especially toward a method for authentication with dynamic and random passwords.

### BACKGROUND

While internet is getting popular, more and more internet services has promoted into the market. A person may obtain services from a remote server through internet by a local client computer. The services, for example, may be transmitting/receiving emails, online shopping, money transactions, paying taxes and more.

In order to maintain safety as a person using the services from internet, it normally require an authentication procedure for indentify the person is a legal user. In general, when a person is connected to a remote server, the server will ask the person to enter his or her account name and corresponding password. The server then allows the person to use the services when the authentication is granted.

However, the conventional way of using strings of account name and the password, which easily suffers from hack activities and login information leakage especially to some malicious software such as Trojan, fishing, or spyware. For example, a cyber criminal may embed a Trojan in HTML codes to a client computer through the bugs existed in the browser. When the browser is activated by the user, the Trojan then is able to steal account name and the password from the user (e.g. the banking account and the corresponding password). Further, the cyber criminal may also monitor or record whole operative activities of the keyboard (commonly known as key logging).

Moreover, similar password stealing software hided in normal downloadable software, attached files in emails, files for P2P (peer-to-peer) transmission, or even built in webpage that triggered automatically when browsing. Therefore, the general public with no skill and knowledge for information security often exposed in the environment of being attacked. It is a duty and great responsible for service provider to provide better security mechanism, which reduce the risk and damages of exposing attacks from malicious intruder.

A one-time password (OTP) is a dynamic password that is valid for only one login session or transaction that has advantage for unpredictable and non-repeatable. OTPs avoid a number of shortcomings that are associated with traditional password strings, which significantly reduces risk of attacks such as Trojan, fishing, spyware, or fake website. The drawback of OTP is that very difficult for a person to memorize, and thus they require additional hardware and/or fee charges in order to work. It is not very suitable for using in a general portal website.

Additionally, there is another dynamic password technology based on graphic for authentication (i.e. CAPTCHA), which allow user to appoint location the predefined figure reference to background graphic as a password. The background graphic for the authentication is randomly generated that is able to prevent somebody peeking to steal the password. However, it is easy for a malicious intruder to breakthrough and/or guesses the password by inference after logon data be captured several times by hacker, like as key logger.

### Some Exemplary Embodiments

These and other needs are addressed by the present invention, wherein an approach is provided for a method for authentication with dynamic and random passwords, which is able to prevent a breakthrough by password cracking and shoulder surfing.

According to one aspect of an embodiment of the present invention, a method for authentication with dynamic and random passwords comprises a predefined mathematical code equation by user through a registration request (i.e. registration page) in a secure manner from server. At the Authentication Phase, when user want to logon the server. Server randomly generate a starting code to user, the password is according the starting code substituted into the predefined code equation generate a result value. When the user wants to login the system. User submits his password should correspond to the starting code for authentication. When server receives the identity and password from the user through an authentication page of the system, determining the identity and the password whether the same to the result value which is substituted the starting code into the user predefined code equation, and granting the person for the authentication when the password and the result value are the same. The code equation is formed by at least one mathematical equation. The result value is the calculation result of the starting code set and the predefined code equation. The starting code set is a set of number randomly generated by the system.

Accordingly, the method comprises acts of obtaining a code equation initially from a person through an register page of a system, generating a starting code set and a result value, obtaining a password from the person through an authentication page of the system, determining the identity of the result value and the password, and granting the person for the authentication when the password and the result value are the same.

In concluded, the actual pass setting is a mathematical equation instead of the conventional password string. The starting code set is generated randomly by the system, whereby the actual password of the present invention can be dynamic and randomly generated in response to the mathematical equation. Since the code equation is preset by the person contained at least one mathematical equation, and the combinations of the mathematical equations can be million kinds. Therefore, the present invention is able to prevent a breakthrough by password cracking or recovering from data that has been captured by key logger.

In one embodiment of the present invention, the numbers of the starting code set randomly generated by the system are sequentially ranked numbers as the parameter for corresponding algebraic variables in the mathematical equation.

In one embodiment of the present invention, the algebraic number may repeat in the single mathematical equation of the code equation.

In one embodiment of the present invention, the code equation may contain more than one mathematical equation, and any algebraic number shown in one mathematical equation may also appear in another mathematical equation.

In one embodiment of the present invention, the code equation contains multiple mathematical equations that are divided in segments by dividing symbols such as commas (“,”).

In one embodiment of the present invention, the code equation may further comprise a dummy number. Each dummy number is configured for setting a fixed digital length, and is set up by a question symbol (“?”) from the person who is given the code equation, and can be any number as considered by the system.

In conclusion, the embodiments proposed in the present invention has advantages of:

(a) Dynamic password (i.e. one time use only), which is able to prevent hack activities such as Trojan, fishing, spyware, Shoulder surfing attack and more;

(b) No additional adding fees;

(c) No specific hardware is required; and

(d) Fully compatible and easy to add to existing authentication system, and thus enhances the security strength.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a flow chart of a method for authentication with dynamic and random passwords in accordance with an embodiment of the present invention;

FIG. 2 is an exemplary diagram of a register page of a system in accordance with an embodiment of the present invention; and

FIG. 3 is an exemplary diagram of an authentication page of a system in accordance with an embodiment of the present invention.

### DESCRIPTION OF THE PREFERRED EMBODIMENT

A method for authentication with dynamic and random passwords is disclosed. In the following description, for the purposes of explanation, numerous specific details are set forth in order to provide a thorough understanding of the present invention. It is apparent, however, to one skilled in the art that the invention may be practiced without specific details or with an equivalent arrangement. In other instances, well-known structures and devices are shown in block diagram form in order to avoid unnecessarily obscuring the embodiments of the present invention.

Although the invention, according to various embodiments, is discussed with respect to a cyber network (e.g., internet), it is recognized by one of ordinary skill in the art that the embodiments of the invention have applicability to any type of cyber network including radio network. Additionally, the various embodiments of the invention are explained using a web page, it is recognized by one of ordinary skill in the art that other visualization of interfaces can be utilized.

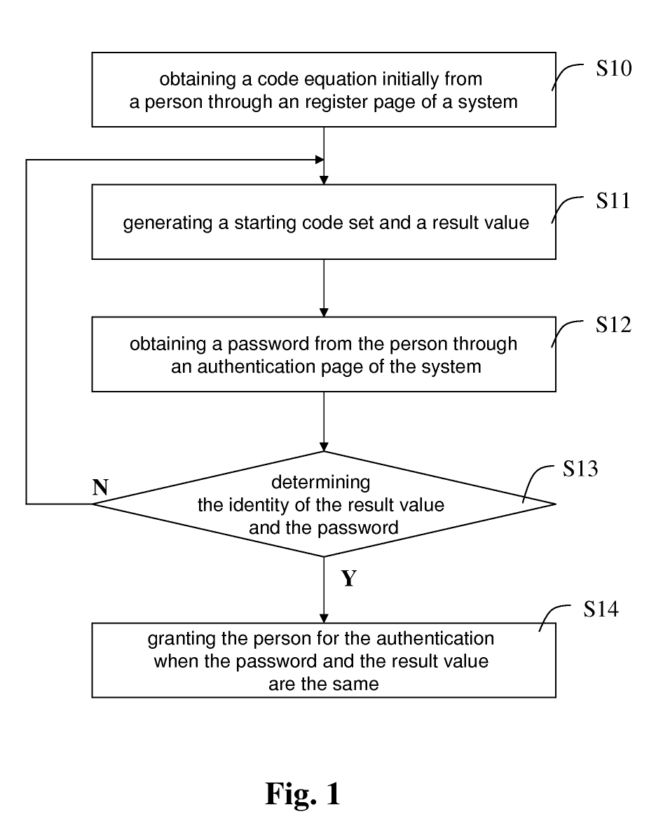

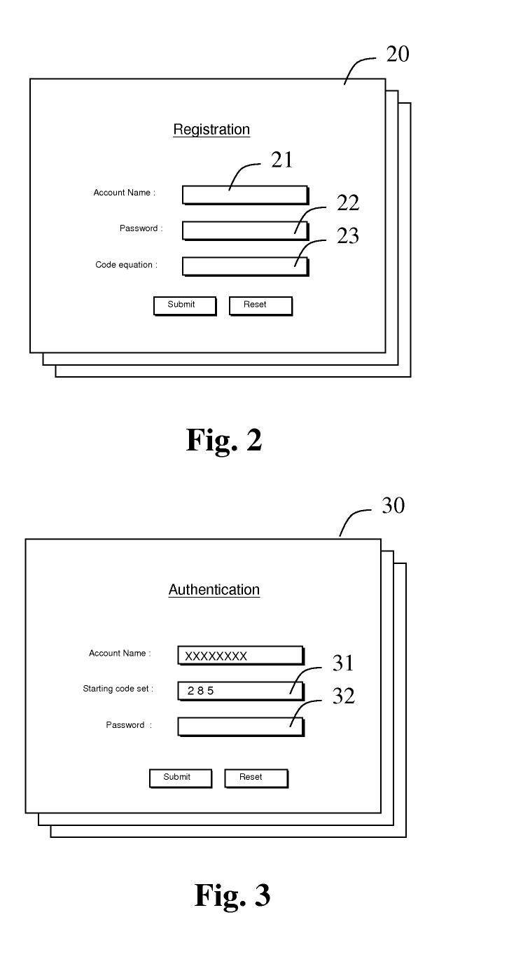

With reference to FIGS. 1 and 2, FIG. 1 is a flow chart of a method for authentication with dynamic and random passwords in accordance with an embodiment of the present invention; FIG. 2 is an exemplary diagram of a register page of a system. In this embodiment, the method comprises acts of S10 obtaining a code equation initially from a person through an register page of a system, S11 generating a starting code set and a result value, S12 obtaining a password from the person through an authentication page of the system, S13 determining the identity of the result value and the password, and S14 granting the person for the authentication when the password and the result value are the same.

In the step of S10, as shown in FIG. 2, the register page 20 of the system comprises three respect columns of account name 21, static password 22 and code equation 23. The static password column is optional. A person may use the register page 20 of FIG. 2 to setup a code equation whereby inputting a mathematical equation with at least one algebraic number (e.g., a+3c or 2b+2) into the code equation column

Further reference to FIG. 3, FIG. 3 is an exemplary diagram of an authentication page of a system. In the step of S11, after a person has registered and every time she or he is attempt login the system, the system will randomly generate a starting code set in numbers. The numbers of the starting code set are sequentially ranked to the symbol order of corresponding algebraic numbers in the mathematical equation. For example, if the code equation is “a+2b+3c”, and the randomly generated starting code set has numbers of (2, 8, 5). The number “2” is corresponded to “a”, number “8” is corresponded to “b”, and “5” is corresponded to “c”. As shown in FIG. 3, the numbers of the starting code set will appear on the authentication page 30. The result value is the calculation result of the starting code set and the code equation. The starting code set is a set of number randomly generated by the system.

In other words, when the starting code set has been generated, the result value is also generated. As the example mentioned above, the numbers of the starting code set is (2, 8, 5) and the result value is calculated as following:

Result value=a+2b+3c=2+16+15 =33.

Accordingly, during the step of S12, when a person is attempted to login the system, the person need to enter the number “33” as a password to the system through the dynamic password column 32 in the authentication page 30 (shown in FIG. 3). The system then compares the saved result value and the entered password (Step S13), and grants the person when the password and the result value are the same (Step S14).

In another embodiment, the code equation may contain more than one mathematical equation, and any algebraic number shown in one mathematical equation may also appear in another mathematical equation. When the code equation contains multiple mathematical equations, the system will assign a dividing symbol between every two mathematical equations. In an embodiment, the dividing symbol may be a comma (“,”). For example, the code equation may be composited two mathematical equations of (a+2b+c, 3b+2c).

In this example, when a person is attempted to login the system with the code equation like this. The system will generate a starting code set with random numbers such as (4, 5, 6), and the result value will be calculated as following:

Result value=a+2b+c, 3b+2c=4+10+6, 15+12 =2027.

Accordingly, in this example, the authentication is granted when the person enter “2027” as a password.

Additionally, when the person next time login to the system, the system generates new starting code set with random numbers, for example, 3, 6, 9. The result value will be calculated as following:

Result value=a+2b+c, 3b+2c=3+12+9, 18+18 =2436.

The system then grants the person when the entered password is “2436”.

Further, in order to enhance the security strength, the method in accordance with the present invention. The system may accept dummy number is configured for setting a fixed digital length by using a question symbol (“?”) when a person sets the code equation. The question symbol represents any number (i.e. 0-9). If the code equation is (?, a+3c, ??, 2b+2,?) and the starting code set is 3, 6, 9. The result person may enter any number in an order as the question symbol is placed. For example, if the person enters 93015142, or 23011147. The system will automatically treat the number located at question symbol as a dummy number and block it (e.g., 9304-M42, or 23044147). The result value and the password remain 3014.

According to various embodiments of the invention, the processes described herein is provided a code equation as a actual pass, which makes the actual password being in response to the starting code set randomly generated by the system. The password entered to the system is different when the person is attempted to login, and thus the authentication is dynamic and random. In contrast, since the code equation is set once when the person registered to the system, it achieves benefit from preventing the equation code being captured or recorded. Further, the password and the starting code set are different every time the person trying to login to the system, and thus the hackers are difficult to crack.

It is also noted that, in various embodiments described above, the algebraic number may repeat in the single mathematical equation of the code equation, the code equation may contain more than one mathematical equation, and any algebraic number shown in one mathematical equation may also appear in another mathematical equation. The combinations of the mathematical equations of the code equation can be million kinds. Therefore, the present invention is able to prevent a breakthrough by password cracking or recovering from data that has been stored in or transmitted by a computer apparatus.

In recognition of the drawbacks of the traditional authentication, the new proposed authentication method is utilized and described herein with respect FIGS. 1-3, and has advantages of dynamic password (i.e. one time use only), which is able to prevent hack activities such as Trojan, fishing, spyware and more; No additional adding fees; No specific hardware is required; and fully compatible and easy to add to existing authentication system, and thus enhances the security strength.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for authentication with dynamic and random passwords, comprising:
obtaining a code equation initially from a person through an register page of a system, wherein the code equation contains at least one mathematical equation with at least one algebraic number;
generating a starting code set and a result value, wherein the starting code set has at least one number randomly generated by the system and the result value is a calculated result of the mathematical equation and the starting code set;
obtaining a password from the person through an authentication page of the system;
determining the identity of the result value and the password; and
granting the person for the authentication when the password and the result value are the same.

2. The method as claimed in claim 1, wherein the numbers in the starting code set randomly generated by the system are sequentially ranked to the symbol order of corresponding algebraic numbers in the mathematical equation.

3. The method as claimed in claim 1, wherein the algebraic number repeats in the single mathematical equation of the code equation.

4. The method as claimed in claim 1, wherein the code equation comprises multiple mathematical equations, and any algebraic number shown in one mathematical equation is allowed to appear in another mathematical equation.

5. The method as claimed in claim 1, wherein the code equation comprises multiple mathematical equations, and any algebraic number shown in one mathematical equation is allowed to repeat in other mathematical equations.

6. The method as claimed in claim 1, wherein the code equation comprises multiple mathematical equations that are divided in segments by dividing symbols.

7. The method as claimed in claim 1, wherein the code equation further comprises a dummy number that is configured for setting a fixed digital length, wherein the dummy number is considered as any number.
